(19) United States
(12) Patent Application Publication
(10) Pub. No.: US 2023/0281536 A1
(43) Pub. Date: Sep. 7, 2023

(54) WORK MANAGEMENT DEVICE, WORK MANAGEMENT METHOD, AND NON-TRANSITORY COMPUTER-READABLE MEDIUM

(71) Applicant: OMRON Corporation, Kyoto (JP)

(72) Inventors: Shinya FUJIMOTO, Kyoto-shi (JP); Yasuhiro UJITA, Kyoto-shi (JP)

(73) Assignee: OMRON Corporation, Kyoto (JP)

(21) Appl. No.: 18/166,462

(22) Filed: Feb. 8, 2023

(30) Foreign Application Priority Data
Mar. 1, 2022 (JP) 2022-030901

(51) Int. Cl. G06Q 10/0631

(52) U.S. Cl. CPC G06Q 10/06316; G06Q 10/063114

(57) ABSTRACT

Data indicating a first time period during which a workpiece as a work object in each of a plurality of work processes stays in a state in which substantial work is possible, a second time period during which a worker stays in a worker area, and a work cycle are acquired. A work type identifier is provided that identifies a work type of each time range included in the second time period based on a relationship between the first time period and the second time period. A time calculator is provided that, with respect to at least one work process, calculates a sum total of time ranges corresponding to at least one work type included in one work cycle.

### CROSS-REFERENCE TO RELATED APPLICATIONS

This application claims the priority benefit of Japan Application No. 2022-030901, filed on Mar. 1, 2022. The entirety of the above-mentioned patent application is hereby incorporated by reference herein and made a part of this specification.

### BACKGROUND

### Technical Field

The disclosure relates to a work management device that manages a work process, for example, at a production site.

### Related Art

Conventionally, it has been known to attempt to use imaging data obtained by imaging a state of implementation of a work process at a production site such as a factory to improve the work process.

In Patent Document 1, a method is disclosed in which a standard work flow line serving as a standard is identified among work flow lines obtained from the imaging data, and deviation of a work flow line from the standard work flow line is regarded as a point to be improved.
[Patent Document 1] Japanese Patent No. 6789590

However, in the related art as described above, a work flow line is derived from information on a worker's position and time. Here, the worker may leave a work area during certain work, perform another work and then return to the original work. Examples of such work include replenishment of parts. A work flow line in this case is a work flow line where the certain work is interrupted, and a work time related to this work may be divided and recorded. In this case, when statistics of work time are collected afterward, since the work time of the corresponding work is statistically processed as a shorter time than that of the actual work, accurate analysis cannot be performed. Also, since it is not determined whether the divided work is normal work, the statistics of work time cannot be accurately collected for the divided work as normally performed work.

### SUMMARY

A work management device includes: a first acquisition part, acquiring data indicating a first time period during which a workpiece as a work object in each of a plurality of work processes stays in a state in which substantial work in the work process is possible; a second acquisition part, acquiring data indicating a second time period during which a worker stays in a worker area corresponding to each of the plurality of work processes; a third acquisition part, acquiring a work cycle of an entirety of the plurality of work processes; a work type identifier, identifying a work type of each time range included in the second time period based on a relationship between the first time period and the second time period; and a time calculator, with respect to at least one of the work processes, calculating a sum total of time ranges corresponding to at least one of the work type included in one of the work cycle.

A work management method includes: first acquisition, in which data indicating a first time period during which a workpiece as a work object in each of a plurality of work processes stays in a state in which substantial work in the work process is possible is acquired; second acquisition, in which data indicating a second time period during which a worker stays in a worker area corresponding to each of the plurality of work processes is acquired; third acquisition, in which a work cycle of an entirety of the plurality of work processes is acquired; work type identification, in which a work type of each time range included in the second time period is identified based on a relationship between the first time period and the second time period; and time calculation, in which, with respect to at least one of the work processes, a sum total of time ranges corresponding to at least one of the work type included in one of the work cycle is calculated.

### BRIEF DESCRIPTION OF THE DRAWINGS

FIG. 1 illustrates a configuration of main parts of a work management device.

FIG. 2 illustrates an overall schematic view of a work management system including a work management device.

FIG. 3 illustrates an image acquired by an information processing device from a position acquisition device.

FIG. 4 illustrates an example of a first time period.

FIG. 5 illustrates an example of a second time period.

FIG. 6 is a diagram of a work flow line obtained by integrating a first time period with a work cycle.

FIG. 7 is a flowchart illustrating operations according to the present embodiment.

FIG. 8 is a work flow line indicating a first time period and a second time period in each work cycle.

FIG. 9 illustrates an example of a relationship between a first time period and a second time period in an automated process.

FIG. 10 illustrates an example of a relationship between a first time period and a second time period in a semi-automated process.

FIG. 11 illustrates an example of a relationship between a first time period and a second time period in a manual process.

FIG. 12 is a stacked bar graph of normal work as an example of statistical processing.

FIG. 13 is a box plot of normal work as an example of statistical processing.

### DESCRIPTION OF THE EMBODIMENTS

In one aspect of the disclosure, appropriate work time is calculated and a work flow line is analyzed for interrupted work.

A work management device according to one aspect of the disclosure includes: a first acquisition part, acquiring data indicating a first time period during which a workpiece as a work object in each of a plurality of work processes stays in a state in which substantial work in the work process is possible; a second acquisition part, acquiring data indicating a second time period during which a worker stays in a worker area corresponding to each of the plurality of work processes; a third acquisition part, acquiring a work cycle of an entirety of the plurality of work processes; a work type identifier, identifying a work type of each time range included in the second time period based on a relationship between the first time period and the second time period; and a time calculator, with respect to at least one of the work processes, calculating a sum total of time ranges corresponding to at least one of the work type included in one of the work cycle.

According to the above configuration, the sum total of time ranges included in one work cycle is calculated for each work type identified based on the relationship between the first time period and the second time period. Thus, even if work is interrupted in a certain work process, a reasonable work time can be calculated for each work type.

The work type identifier may refer to information in which the relationship between the first time period and the second time period is associated with the work type for each process classification, thereby identifying the work type according to the process classification associated with the work process.

According to the above configuration, the work type based on the relationship between the first time period and the second time period can be identified according to the process classification. Thus, the work type can be relatively appropriately identified.

The process classification may include at least an automated process normally implemented only by work performed by an automated device without requiring the worker, a semi-automated process implemented by work of a semi-automated device and requiring preparation and post-processing performed by the worker, and a manual process performed by the worker.

According to the above configuration, the automated process, the semi-automated process and the manual process can be included as the process classification. According to these process classifications, the relationship between the first time period and the second time period can be considered in a different way. Hence, the work type can be accurately determined.

In the case where the work process is associated with the automated process, the work type identifier may identify the work type of each time range included in the second time period as non-normal work.

If work is performed normally in the automated process, it can be assumed that the second time period will not occur. That is, according to the above configuration, non-normal work can be identified in the automated process.

In the case where the work process is associated with the semi-automated process, the work type identifier may identify the work type of each time range included in the second time period that does not overlap the first time period as normal work corresponding to the preparation and the post-processing, and may identify the work type of each time range included in the second time period that overlaps the first time period as non-normal work.

If work is performed normally in the semi-automated process, it can be assumed that the second time period will not occur in the first time period. That is, according to the above configuration, non-normal work can be identified in the semi-automated process.

In the case where the work process is associated with the manual process, the work type identifier may identify the work type of each time range included in the second time period that overlaps the first time period as normal work, and may identify the work type of each time range included in the second time period that does not overlap the first time period as non-normal work.

If work is performed normally in the manual process, it can be assumed that the second time period will not occur outside the first time period. That is, according to the above configuration, non-normal work can be identified in the manual process.

A statistical processing part may further be provided that outputs a statistical result based on a history of a sum total of time ranges corresponding to the work type identified as the normal work in the work process that is predetermined.

According to the above configuration, statistical processing can be performed using a work flow line. In particular, by performing statistical processing on a result classified as normal work, a work status of normally performed work can be verified.

A display control part may further be provided that controls display so that a horizontal axis indicates passage of time, and the first time period and the second time period in the work process that is predetermined are displayed in different display formats.

According to the above configuration, by displaying the first time period and the second time period in different display formats, a user is able to check passage of time of a work status of each work process in more detail.

A work management method according to another aspect of the disclosure includes: a first acquisition step, in which data indicating a first time period during which a workpiece as a work object in each of a plurality of work processes stays in a state in which substantial work in the work process is possible is acquired; a second acquisition step, in which data indicating a second time period during which a worker stays in a worker area corresponding to each of the plurality of work processes is acquired; a third acquisition step, in which a work cycle of an entirety of the plurality of work processes is acquired; a work type identification step, in which a work type of each time range included in the second time period is identified based on a relationship between the first time period and the second time period; and a time calculation step, in which, with respect to at least one of the work processes, a sum total of time ranges corresponding to at least one of the work type included in one of the work cycle is calculated.

A work management program according to another aspect of the disclosure is a work management program for causing a computer to function as the aforesaid work management device, in which the work management program causes the computer to function as the first acquisition part, the second acquisition part, the third acquisition part, the work type identifier and the time calculator.

According to one aspect of the disclosure, even if the worker interrupts the work during the work, a work time can be measured.

### Embodiment 1

An embodiment (hereinafter also written as “the present embodiment”) according to one aspect of the disclosure is hereinafter described based on the drawings. The same or equivalent portions in the drawings are denoted by the same signs, and description thereof will not be repeated.

In the following description, “n” indicates “an integer equal to or greater than 1”.

### § 1 Application Example

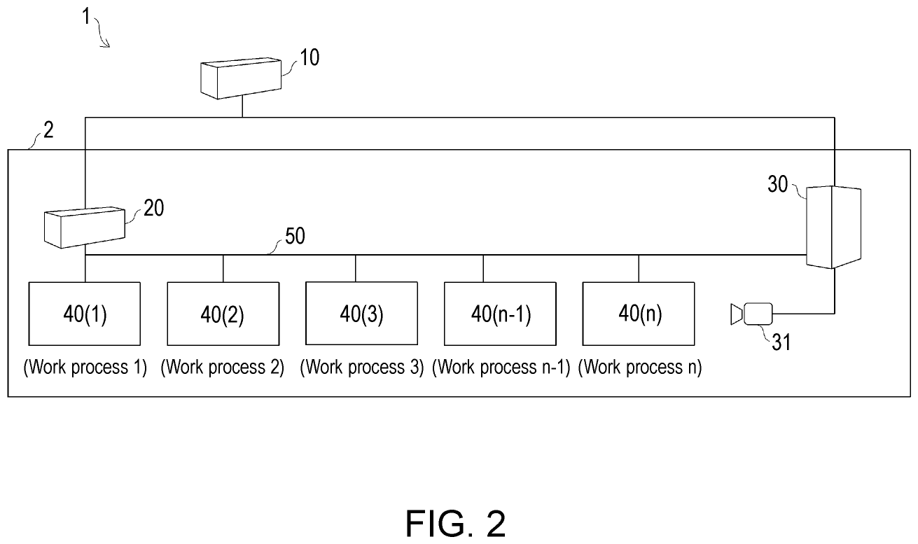

To facilitate understanding of a work management device 10 according to one aspect of the disclosure, first, an overview of a work management system 1 including the work management device 10 is described with reference to FIG. 2.

FIG. 2 illustrates an overall schematic view of the work management system 1 including the work management device 10. In the work management system 1, by at least one work management device 10, information acquired from a control system 2 provided at a worksite WS is analyzed.

In the control system 2, by a programmable logic controller (PLC) 20 that manages a plurality of work processes Pr, a staying time of a workpiece in each work process Pr is acquired from an operation history of a machine 40. Furthermore, in the control system 2, a position of a worker Pe at the worksite WS is measured using a position acquisition device 31, and which work process Pr each worker is engaged in is analyzed by an information processing device 30. A relationship between the staying time of the workpiece in each work process Pr and an engagement time (staying time) of the worker is analyzed, and a normal work time and a non-normal work time are calculated based on a process classification of each work process.

There are cases where the worker may need to go back and forth between the work processes Pr. While the worker is engaged in a certain work process Pr, they may be interrupted and be engaged in another work process Pr. Hence, time spent on the work process Pr may be divided. In such a case, divided work times spent on the work process Pr are added up for each predetermined cycle.

By statistically processing the work time for each work process Pr, waste in the work process Pr can be discovered, leading to process improvement.

### § 2 Configuration Example

(Configuration of Work Management System 1)

The work management system 1 includes the work management device 10 and the control system 2.

The control system 2 is a system acquiring a movement (staying time) of a workpiece and a worker at the worksite WS and outputting it to the work management device 10.

The work management device 10 analyzes the work process Pr using the input staying time of the workpiece and the worker, and presents information leading to process improvement. Examples of the work management device include a personal computer and an industrial PC (IPC).

(Configuration of Control System 2)

The control system 2 includes the PLC 20 connecting a plurality of machines 40 by a control network 50 and the information processing device 30 connecting the position acquisition device 31.

The PLC 20 is a control device (controller) that controls the entire control system 2, and is communicatively connected to each of the plurality of machines 40. The PLC 20 acquires, as input data, information from each of the plurality of machines 40 as input devices (measurement devices). The PLC 20 executes arithmetic processing using the acquired input data in accordance with a preinstalled user program. The PLC 20 executes the arithmetic processing and determines control content with respect to the control system 2. For example, the PLC 20 determines the control content for each of the plurality of machines 40 as output devices such as actuators, and outputs control data corresponding to the control content to each of the plurality of machines 40. The PLC 20 repeatedly executes the acquisition of input data from each of the plurality of machines 40 and the output of control data to each of the plurality of machines 40 in a predetermined cycle (control cycle). The PLC 20 may be connected to, for example, a display part and an operation part (both not shown). The display part is composed of a liquid crystal panel or the like that is able to display an image, and the operation part is typically composed of a touch panel, a keyboard, a mouse, or the like.

The machine 40 is a machine controlled by the PLC 20. The machine 40 is an input device that repeatedly transmits the input data to the PLC 20 for each predetermined control cycle, or an output device that repeatedly receives the control data from the PLC 20 and operates in accordance with the received control data for each predetermined control cycle. The machine 40 may be, for example, a sensor (for example, photoelectric sensor) as an input device that transmits a detection result or the like as the input data to the PLC 20, or may be a barcode reader that transmits a read result, or may be a tester that transmits an inspection result. The machine 40 may be a programmable terminal (PT) to which a plurality of input devices are connected. Furthermore, the machine 40 may be a robot or the like as an output device that performs screw tightening, picking or the like.

The control network 50 transmits various data received by the PLC 20 or transmitted by the PLC 20. Typically, various industrial Ethernet (registered trademark) networks can be used, and they are sometimes called field networks. Known examples of industrial Ethernet (registered trademark) include EtherCAT (registered trademark), Profinet IRT, MECHATROLINK (registered trademark)-III, Powerlink, SERCOS (registered trademark)-III, and CIP Motion, and any of them may be employed. Furthermore, a field network other than an industrial Ethernet (registered trademark) network may be used. For example, if motion control is not performed, DeviceNet, CompoNet/IP (registered trademark), or the like may be used.

The information processing device 30 outputs, to the work management device 10, the position of the worker Pe at the worksite WS that is measured by the position acquisition device 31. The position acquisition device 31 is a device that acquires the position of the worker Pe, and is a ceiling mounted wide angle camera.

(Regarding Work Process Pr and Worker Pe)

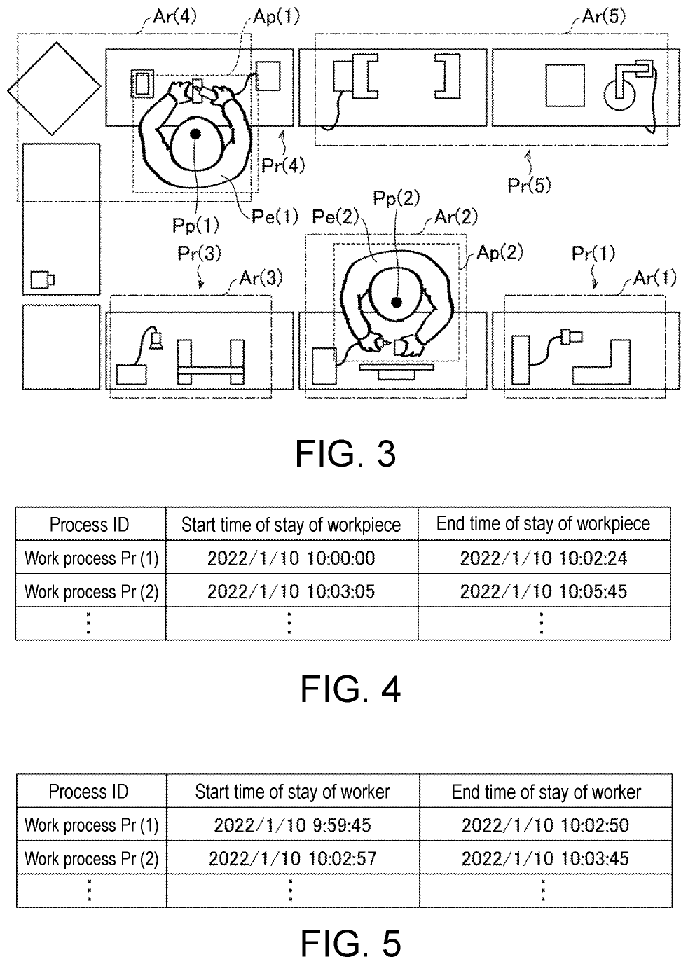

FIG. 3 illustrates an image acquired by the information processing device 30 from the position acquisition device 31. The information processing device 30 subjects the image to image analysis, and determines whether the worker Pe is present at the worksite WS. If it is determined that the worker Pe is present at the worksite WS, a worker ID of the worker Pe present at the worksite WS is identified.

A plurality of work processes Pr are performed at the worksite WS. If it is necessary to distinguish between each work process, a suffix such as “(1)”, “(2)”, “(3)”, . . . , and “(n)” as a sign is attached for distinction; if not particularly necessary, the work process is simply referred to as “work process Pr”.

There may be a plurality of workers Pe at a worksite. If it is necessary to distinguish between each worker, a suffix such as “(1)”, “(2)”, “(3)”, . . . , and “(n)” as a sign is attached for distinction; if not particularly necessary, the worker is simply referred to as “worker Pe”.

A worker area Ar is defined for each work process Pr. The worker area Ar is an area where the presence of the worker Pe in the worker area Ar is determined. If it is necessary to distinguish between each worker area, a suffix such as “(1)”, “(2)”, “(3)”, . . . , and “(n)” as a sign is attached for distinction; if not particularly necessary, the worker area is simply referred to as “worker area Ar”.

In the case where the worker Pe is present in the worker area Ar according to the image analysis, the information processing device 30 sets a rectangular area Ap surrounding the worker Pe. A center point of the rectangular area Ap is taken as a position Pp of the worker Pe. If it is necessary to distinguish between each rectangular area Ap and each position Pp, a suffix such as “(1)”, “(2)”, “(3)”, . . . , and “(n)” as a sign is attached for distinction.

(Regarding Work Management Device 10)

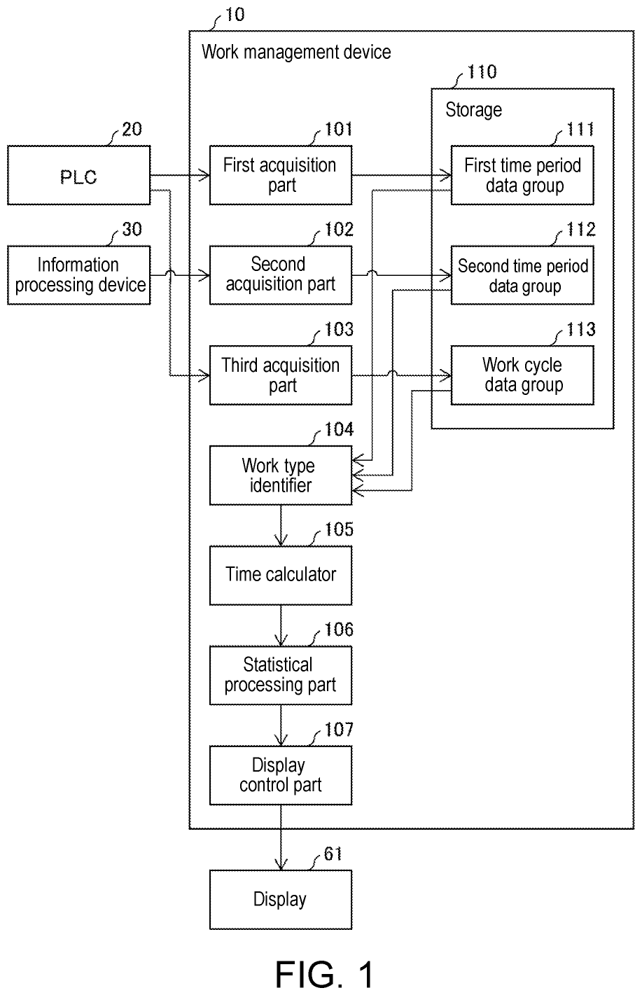

FIG. 1 illustrates a configuration of main parts of the work management device 10. The work management device 10 includes a first acquisition part 101, a second acquisition part 102, a third acquisition part 103, a work type identifier 104, a time calculator 105, a statistical processing part 106, a display control part 107, and a storage 110.

The first acquisition part 101 acquires from the PLC 20 a signal for determining a state of each work process Pr, determines when each work process Pr was performed, and sets a first time period. The first time period is a period of time during which a workpiece as a work object in each of a plurality of work processes stays in a state in which substantial work in the work process is possible. Data input from the machine 40 to the PLC 20 is used as information for determination. Specifically, the first time period is a period of time during which a sensor detects that the workpiece is ready for work, or a period of time during which a robot performs screw tightening, picking or the like. The first time period is not limited to the above and may be any period using a signal acquired from the PLC 20. The first acquisition part 101 stores the first time period in a first time period data group 111 of the storage 110.

FIG. 4 illustrates an example of the first time period. As shown in FIG. 4, during the first time period, information for discriminating the work process Pr as a target and times when a workpiece starts and ends a stay are recorded.

The second acquisition part 102 acquires from the information processing device 30 the position Pp of the worker Pe, determines when the worker Pe performed each work process Pr, and sets a second time period. That is, the second time period is a period of time during which the worker Pe stays in the worker area Ar corresponding to each of the plurality of work processes Pr. The second acquisition part 102 stores the second time period in a second time period data group 112 of the storage 110.

FIG. 5 illustrates an example of the second time period. As shown in FIG. 5, during the second time period, information for discriminating the work process Pr as a target and times when a worker starts and ends a stay are recorded. The second time period may not necessarily include information on which worker Pe was engaged in the work in the work process Pr.

The third acquisition part 103 acquires from the PLC 20 a timing at which all of the plurality of work processes Pr are started or ended as a work cycle. The third acquisition part 103 stores the work cycle in a work cycle data group 113 of the storage 110.

Based on a relationship between the first time period and the second time period, the work type identifier 104 identifies a work type of each time range included in the second time period. The work type is broadly classified into normal work and non-normal work. Normal work is work that is substantially necessary for manufacturing, such as machining and inspection of a workpiece. Non-normal work is work that is not substantially necessary for manufacturing, such as changeover or troubleshooting. That is, the work type identifier 104 determines whether work performed by the worker Pe substantially contributes to manufacturing in the work process Pr.

The work type identifier 104 identifies the work type in accordance with a process classification predefined for each work process Pr. That is, the work type identifier 104 refers to information in which the relationship between the first time period and the second time period is associated with the work type for each process classification, thereby identifying the work type according to the process classification associated with the work process. Here, the process classifications include at least automated process, semi-automated process, and manual process, and details of these process classifications will be described later.

With respect to at least one work process Pr, the time calculator 105 calculates the sum total of time ranges corresponding to at least one work type included in one work cycle. That is, for each work cycle, the work divided into a plurality of second time periods is integrated, and the time required for each work type is calculated.

The statistical processing part 106 performs statistical processing based on a history of the sum total of time ranges corresponding to the work type identified as normal work in a predetermined work process Pr. The statistical processing part 106 outputs a result of statistical processing to the display control part 107. The result of statistical processing may be saved (output) as data in a file.

The display control part 107 displays on the display 61 a result of analysis of the first time period and the second time period performed by the work management device 10. A work flow line may be displayed as content to be displayed. A result of statistical processing analyzed by the statistical processing part 106 may also be displayed.

Regarding the display of the work flow line, the horizontal axis indicates passage of time, and the first time period and the second time period in the predetermined work process Pr are displayed in different display formats. That is, the first time period and the second time period are displayed so that they can be easily compared and discussed.

The storage 110 stores data and programs used by the work management device 10. The data includes the first time period data group 111, the second time period data group 112, and the work cycle data group 113.

(Regarding Work Flow Line)

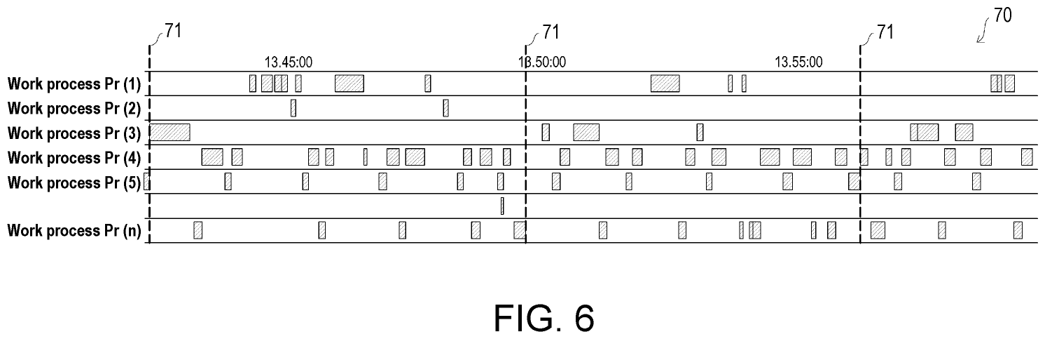

FIG. 6 is a diagram of a work flow line 70 obtained by integrating a first time period with a work cycle. The work flow line is a diagram in which the vertical axis represents the work process Pr and the horizontal axis represents passage of time. A work cycle is represented by sign 71. In the case where the work processes Pr are arranged in order from top to bottom, it is common that the work processes Pr flow from the upper left to the lower right for each work cycle 71.

However, the same work process Pr may be performed many times within a single work cycle 71, as shown in FIG. 6. This is a case where the work process Pr is not completed at once, but has been interrupted and resumed.

### § 3 Operation Example

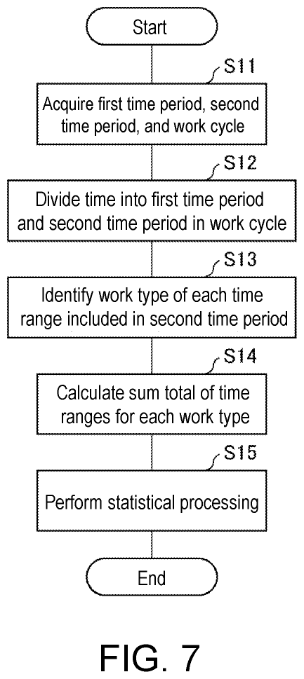

FIG. 7 is a flowchart illustrating operations according to the present embodiment.

In S11, the first acquisition part 101 acquires the first time period from the first time period data group 111, the second acquisition part 102 acquires the second time period from the second time period data group 112, and the third acquisition part 103 acquires the work cycle from the work cycle data group 113.

In S12, the first acquisition part 101 and the second acquisition part 102 respectively divide the first time period and the second time period for each work cycle, and a work flow line is created.

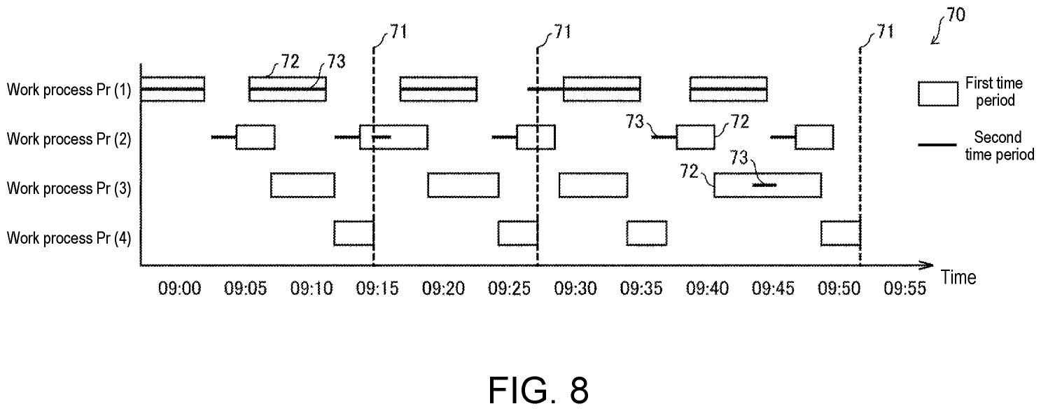

FIG. 8 illustrates the work flow line 70 indicating the first time period and the second time period in each work cycle. In the work flow line 70, the work cycle is represented by sign 71, the first time period is represented by a square by sign 72, and the second time period is represented by a line segment by sign 73. Sign 72 and sign 73 are displayed overlapping for each same work process Pr. A time length of the first time period is a length of the square (sign 72), and a time length of the second time period is a length of the line segment (sign 73). The way of displaying the first time period and the second time period is not limited to the above, and the first time period and the second time may be displayed in any different display formats.

(Regarding Process Classification)

In S13, the work type identifier 104 identifies the work type of each time range included in the second time period.

As shown in FIG. 8, if there is a work process present with only the first time period, there is also a work process in which the second time period is present in addition to the first time period. In this way, the process classification is determined according to a relationship between the first time period and the second time period in the same work process. There are at least three process classifications, namely, automated process, semi-automated process, and manual process. The process classification is determined and set by a user according to each work process Pr.

An automated process is the work process Pr normally implemented only by work performed by an automated device without requiring the worker Pe. That is, in the work process Pr belonging to the automated process, processing (such as machining, mounting of parts, and inspection) on a workpiece is automatically executed by one or more machines 40. Hence, in the case where one or more machines 40 operate normally, the worker Pe is not involved in the work process Pr belonging to the automated process.

A semi-automated process is the work process Pr requiring preparation and post-processing by the worker Pe. That is, in the work process Pr belonging to the semi-automated process, for the processing (such as machining, mounting of parts, and inspection) on a workpiece by one or more machines 40, preparation work (for example, loading work) or post-processing work (for example, unloading work) is performed by the worker Pe.

A manual process is the work process Pr configured by work performed by the worker Pe. That is, one or more machines 40 and the worker Pe cooperate to execute the processing (such as machining, mounting of parts, and inspection) on a workpiece.

(Regarding Automated Process)

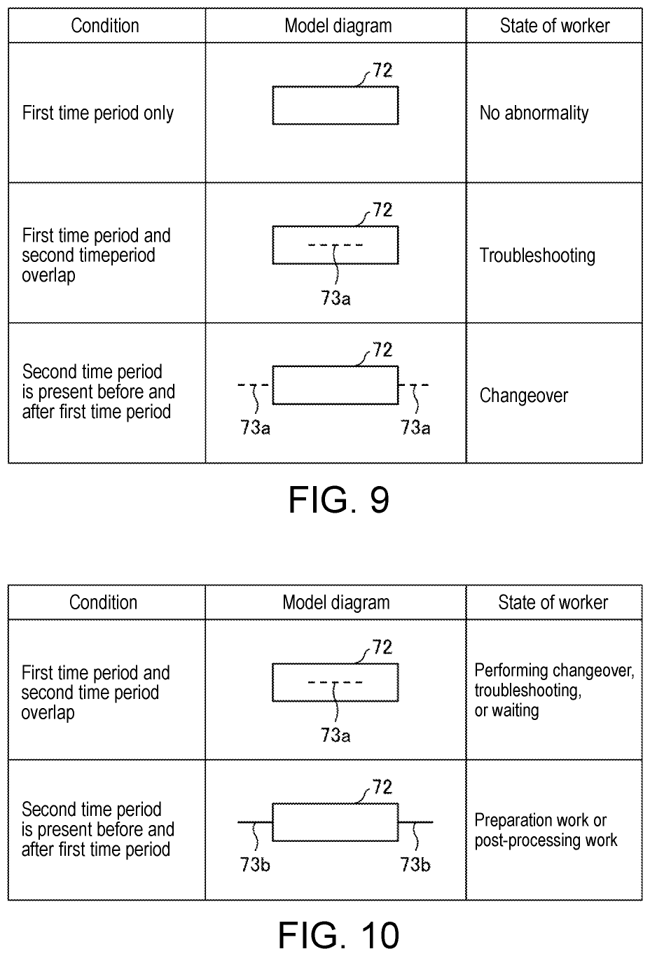

FIG. 9 illustrates an example of a relationship between the first time period and the second time period in the automated process. As described above, in the case where one or more machines 40 operate normally, if work is performed normally in the work process Pr belonging to the automated process, it can be assumed that the worker Pe is not involved and the second time period will not occur. Hence, a time corresponding to the second time period in the automated process is non-normal work.

Specifically, in the case where there is only the first time period 72 with no second time period present, the work type of the work process Pr is that the worker Pe is not engaged in the work. Hence, in this case, neither time of normal work nor time of non-normal work is present.

In the case where the first time period 72 and a second time period 73a overlap, the work type of the work process Pr indicates that the worker Pe is performing troubleshooting as non-normal work.

Furthermore, in the case where the second time period 73a is present before and after the first time period 72, the work type of the work process Pr indicates that the worker Pe is performing a changeover as non-normal work.

Accordingly, in the case where the work process Pr is associated with the automated process, the work type identifier 104 identifies the work type of each time range included in the second time period as non-normal work.

(Regarding Semi-Automated Process)

FIG. 10 illustrates an example of a relationship between the first time period and the second time period in the semi-automated process. As described above, if work is performed normally in the work process Pr belonging to the semi-automated process, it can be assumed that the preparation work and/or post-processing work is performed by the worker Pe and the second time period will not occur in the first time period. Hence, the second time period in the semi-automated process is ideally present before and after the first time period.

Specifically, in the case where the first time period 72 and the second time period 73a overlap, the work type of the work process Pr indicates that the worker Pe is performing a changeover, troubleshooting, or waiting as non-normal work.

In the case where a second time period 73b is present before and after the first time period 72, the work type of the work process Pr indicates that the worker Pe is performing preparation work or post-processing work as normal work.

Accordingly, in the case where the work process Pr is associated with the semi-automated process, the work type identifier 104 identifies the work type of each time range included in the second time period that does not overlap the first time period as normal work corresponding to preparation and post-processing, and identifies the work type of each time range included in the second time period that overlaps the first time period as non-normal work.

(Regarding Manual Process)

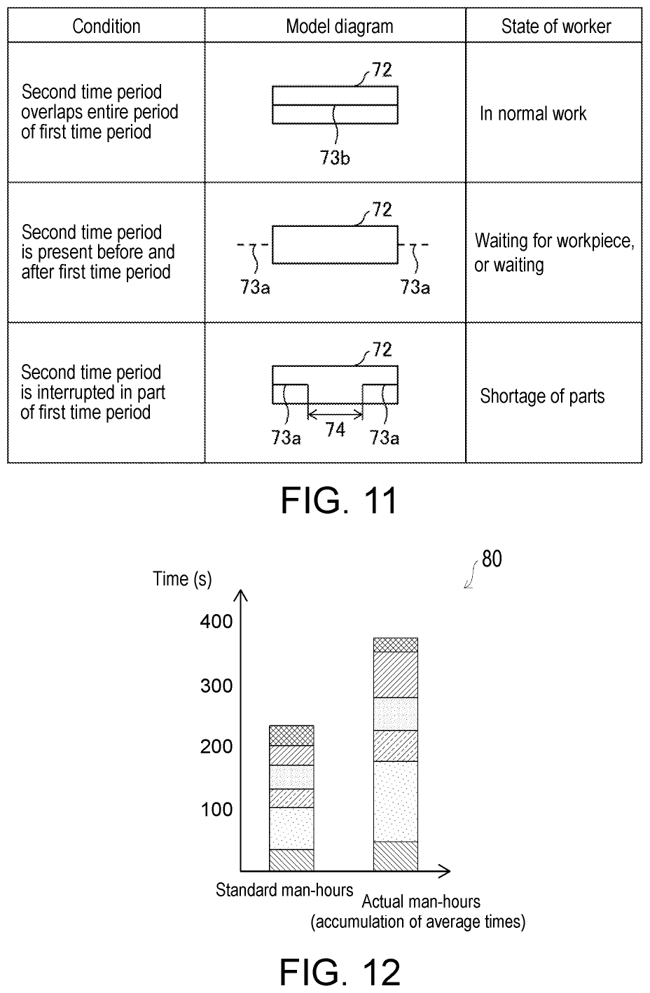

FIG. 11 illustrates an example of a relationship between the first time period and the second time period in the manual process. As described above, if work is performed normally in the work process Pr belonging to the manual process, it can be assumed that the worker Pe and one or more machines 40 cooperate to perform processing on a workpiece, and the second time period will not occur outside the first time period. Hence, if work is performed normally, the second time period in the manual process overlaps the first time period in the same period.

Specifically, in the case where the second time period 73b overlaps the entire period of the first time period 72, the work type of the work process Pr is that the worker Pe is performing processing on a workpiece as normal work.

In the case where the second time period 73a is present before and after the first time period 72, the work type of the work process Pr indicates that the worker Pe is waiting for a workpiece or waiting as non-normal work.

Furthermore, if the second time period 73b is interrupted in part of the first time period 72, only a period 74 during which the interruption occurs indicates that the worker Pe is replenishing parts due to shortage of parts as non-normal work. Hence, the work type of the work process Pr indicates that the worker Pe is performing processing on a workpiece as normal work and is replenishing parts due to shortage of parts.

Accordingly, in the case where the work process Pr is associated with the manual process, the work type identifier 104 identifies the work type of each time range included in the second time period that overlaps the first time period as normal work, and identifies the work type of each time range included in the second time period that does not overlap the first time period as non-normal work.

(Regarding Time Calculator 105)

In S14, with respect to at least one work process Pr, the time calculator 105 calculates the sum total of time ranges corresponding to at least one work type included in one work cycle. For example, the sum total of time ranges for each work process Pr may be calculated. For example, the sum total of time ranges for each work type such as preparation work and changeover work may be calculated.

(Regarding Statistical Processing Part 106)

In S15, the statistical processing part 106 performs statistical processing based on the history of the sum total of time ranges corresponding to the work type identified as normal work, and outputs a result of statistical processing to the display control part 107.

FIG. 12 is a stacked bar graph 80 of normal work as an example of statistical processing. In FIG. 12, accumulation of standard man-hours of the work process Pr and accumulation of actual man-hours using a time range calculated from the first time period and the second time period are compared. The actual man-hours may be obtained by accumulating average times.

According to FIG. 12, which work process Pr takes time and the work process Pr that takes more actual man-hours than the standard man-hours are known, and the work process Pr that should be improved becomes clear.

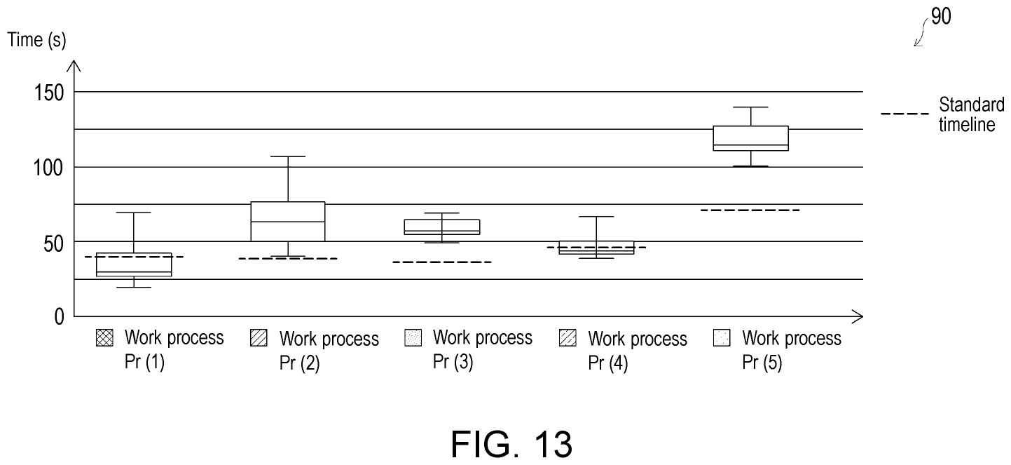

FIG. 13 is a box plot 90 of normal work as an example of statistical processing. In FIG. 13, a degree of distribution of an implementation result of each work process Pr can be confirmed by a box and a whisker. In FIG. 13, by showing a standard timeline representing a standard work time together, deviation from the standard work time may be understood at a glance.

The display control part 107 displays a result of statistical processing on the display 61. The content to be displayed may be a summary of the work flow line 70, the stacked bar graph 80, the box plot 90 or the like displayed together on a divided screen. A histogram or the like of each work process Pr may be displayed.

### § 4 Action and Effects

By the time calculator 105, each time range included in the second time period can be summed up for each work type. Hence, even if work is interrupted in a certain work process, by summing up the time of the work process in a work cycle, the work process can be set to a reasonable work time. Hence, analysis can be performed according to a work flow line based on the reasonable work time.

By the work type identifier 104, according to the relationship between the first time period and the second time period, what kind of work was performed in each time range included in the second time period can be identified. In particular, since it is identified whether each work is normal work or non-normal work, the sum total of normal work that contributed to production can be calculated.

Here, in identifying the work type, the process classification of each work process as an automated process, a semi-automated process, and a manual process can be considered. Hence, the work type can be accurately determined.

Furthermore, by the statistical processing part 106 and the display control part 107, statistical processing of a work flow line and display of a result thereof can be performed, and the user is able to easily analyze the work flow line. In particular, since statistical processing is performed on a result classified as normal work, it is possible to verify a work status of normally performed work.

### § 5 Modifications

(Statistical Processing of Non-Normal Work) In the time calculator 105, the sum total of not only normal work but also non-normal work may be calculated. In the statistical processing part 106, statistical processing may be performed on non-normal work rather than normal work.

By performing statistical processing of non-normal work, the non-normal work can be analyzed and a point to be improved can be discovered.

(Position Acquisition Device)

In Embodiment 1, a wide angle camera is used as the position acquisition device 31. However, the disclosure is not limited thereto. The position acquisition device 31 may be any device that finds a position of the worker Pe.

For example, the worker Pe has a radio frequency identification (RFID) tag, and the RFID tag outputs an antenna strength for a plurality of antennas to the information processing device 30 via the antennas. By measuring the antenna strength for a plurality of antennas, the position Pp of the worker Pe can be identified by applying triangulation.

A beacon or the like may be used as the position acquisition device 31.

(Display by Process Classification and Work Type)

Different display forms may be taken for each process classification. Specifically, a color may be changed or a line type may be changed for each process classification. Accordingly, the user is able to perform analysis by considering even the process classification simply by confirming the work flow line 70.

Different display forms may also be taken according to the work type. Accordingly, whether the second time period in each work cycle is normal work or non-normal work and details of work content are known at a glance, and the user may easily carry out improvements.

[Implementation Example by Software]

A function of the work management device 10 (hereinafter referred to as “device”) can be realized by a program for causing a computer to function as each control block of the device, which is a program for causing a computer to function as the device.

In this case, the above device includes, as hardware for executing the above program, a computer including at least one control device (for example, processor) and at least one storage device (for example, memory). By executing the above program by the control device and the storage device, each function described in each embodiment above is realized.

The above program may be recorded on one or more non-transitory computer-readable recording media. The recording medium may or may not be included in the above device. In the latter case, the above program may be supplied to the above device via any wired or wireless transmission medium.

Some or all of the functions of each control block above may also be realized by a logic circuit. For example, an integrated circuit in which a logic circuit functioning as each control block above is formed is also included in the scope of the disclosure. In addition, it is also possible to realize the function of each control block above by, for example, a quantum computer.

Each processing described in each embodiment above may be executed by artificial intelligence (AI). In this case, the AI may be operated by the above control device, or may be operated by another device (for example, an edge computer or a cloud server).

### ADDITIONAL NOTES

The disclosure is not limited to the embodiments described above, and may be modified in various ways within the scope of the claims. An embodiment derived from a proper combination of technical means disclosed in respective different embodiments is also encompassed in the technical scope of the disclosure.

What is claimed is:

1. A work management device, comprising:
a first acquisition part, acquiring data indicating a first time period during which a workpiece as a work object in each of a plurality of work processes stays in a state in which substantial work in the work process is possible;
a second acquisition part, acquiring data indicating a second time period during which a worker stays in a worker area corresponding to each of the plurality of work processes;
a third acquisition part, acquiring a work cycle of an entirety of the plurality of work processes;
a work type identifier, identifying a work type of each time range comprised in the second time period based on a relationship between the first time period and the second time period; and
a time calculator, with respect to at least one of the work processes, calculating a sum total of time ranges corresponding to at least one of the work type comprised in one of the work cycle.

2. The work management device according to claim 1, wherein
the work type identifier refers to information in which the relationship between the first time period and the second time period is associated with the work type for each process classification, thereby identifying the work type according to the process classification associated with the work process.

3. The work management device according to claim 2, wherein
the process classification comprises at least an automated process normally implemented only by work performed by an automated device without requiring the worker, a semi-automated process implemented by work of a semi-automated device and requiring preparation and post-processing performed by the worker, and a manual process performed by the worker.

4. The work management device according to claim 3, wherein,
in response to the work process being associated with the automated process, the work type identifier identifies the work type of each time range comprised in the second time period as non-normal work.

5. The work management device according to claim 3, wherein,
in response to the work process being associated with the semi-automated process, the work type identifier identifies the work type of each time range comprised in the second time period that does not overlap the first time period as normal work corresponding to the preparation and the post-processing, and identifies the work type of each time range comprised in the second time period that overlaps the first time period as non-normal work.

6. The work management device according to claim 3, wherein,
in response to the work process being associated with the manual process, the work type identifier identifies the work type of each time range comprised in the second time period that overlaps the first time period as normal work, and identifies the work type of each time range comprised in the second time period that does not overlap the first time period as non-normal work.

7. The work management device according to claim 5, further comprising:
a statistical processing part, outputting a statistical result based on a history of a sum total of time ranges corresponding to the work type identified as the normal work in the work process that is predetermined.

8. The work management device according to claim 6, further comprising:
a statistical processing part, outputting a statistical result based on a history of a sum total of time ranges corresponding to the work type identified as the normal work in the work process that is predetermined.

9. The work management device according to claim 1, further comprising:
a display control part, controlling display so that a horizontal axis indicates passage of time, and the first time period and the second time period in the work process that is predetermined are displayed in different display formats.

10. A work management method, comprising:
first acquisition, in which data indicating a first time period during which a workpiece as a work object in each of a plurality of work processes stays in a state in which substantial work in the work process is possible is acquired;
second acquisition, in which data indicating a second time period during which a worker stays in a worker area corresponding to each of the plurality of work processes is acquired;
third acquisition, in which a work cycle of an entirety of the plurality of work processes is acquired;
work type identification, in which a work type of each time range comprised in the second time period is identified based on a relationship between the first time period and the second time period; and
time calculation, in which, with respect to at least one of the work processes, a sum total of time ranges corresponding to at least one of the work type comprised in one of the work cycle is calculated.

11. A non-transitory computer-readable medium storing a work management program for causing a computer to function as the work management device according to claim 1, wherein the work management program causes the computer to function as the first acquisition part, the second acquisition part, the third acquisition part, the work type identifier and the time calculator.
